(19) United States
(12) Patent Application Publication
(10) Pub. No.: US 2026/0258872 A1
(43) Pub. Date: Sep. 3, 2026

(54) CONSTANT FLOW-RATE VALVE

(71) Applicants: Marmon Foodservice Technologies, Inc., Osseo, MN (US); Cornelius (Tianjin) Co., Ltd., Tianjin (CN)

(72) Inventors: Brian Mastro, Des Plaines, IL (US); Jacob C. Greenberg, Elgin, IL (US); Joel S. Paustian, Buffalo Grove, IL (US); Christopher F. Zemko, Elgin, IL (US); Yulong Liu, Tianjin (CN); Qi Zheng, Tianjin (CN); Fushun Lv, Tianjin (CN); Wei Xing, Tianjin (CN); Peiyuan Yang, Tianjin (CN); Tinghao Chen, Tianjin (CN)

(73) Assignees: Marmon Foodservice Technologies, Inc., Osseo, MN (US); Cornelius (Tianjin) Co., Ltd., Tianjin (CN)

(21) Appl. No.: 19/551,398

(22) Filed: Feb. 26, 2026

(30) Foreign Application Priority Data
Feb. 28, 2025 (CN) 202520348399.6

(51) Int. Cl. F16K 7/16; F16K 31/06

(52) U.S. Cl. CPC F16K 7/16; F16K 31/06

(57) ABSTRACT

A constant flow device includes a valve body having an inlet portion with a fluid inlet and an outlet portion with a fluid outlet, the inlet portion and outlet portion forming a cavity. An adjustment plug is configured for at least partial insertion in the cavity and axial engagement with the sleeve. A piston forms a fluid passage in fluid communication with the fluid inlet and the fluid outlet. A biasing member is positioned between the adjustment plug and the piston to provide an elastic force on the piston toward the fluid inlet.

### CROSS-REFERENCE TO RELATED APPLICATIONS

This application claims priority of Chinese Utility Model Application Number 202520348399.6, filed on Feb. 28, 2025. The entire contents of which is hereby incorporated by reference.

### BACKGROUND

The present disclosure relates to the field of beverage dispensing. More particularly, the present disclosure relates to valves for the dispense of beverages.

Beverage dispensing machines are widely used to dispense beverages to operators in different settings (e.g., restaurants, convenience stores), and the machines can be configured to dispense a variety of beverages. In certain examples, the machines include beverage dispensing valves that are each configured to dispense a specific mixed beverage to the operator. The valve receives and dispenses one or more diluents or base fluids (e.g., still water, carbonated water) and one or more syrups (e.g., flavoring concentrate) that mix together and thereby form the dispensed beverage.

Existing technologies in the field of mechanical valves for fluid control often face challenges related to maintaining fixed flow ratios. Many current systems utilize adjustable flow control mechanisms, which, while offering flexibility, can lead to variability in the dispensed product. This variability can result from factors such as wear and tear, manual adjustments, or environmental conditions affecting the valve's performance. Additionally, the need for frequent recalibration of these systems can lead to increased maintenance costs and downtime, impacting operational efficiency. Additionally, maintenance drives cost of ownership and therefore solutions that reduce maintenance can be desirable to reduce overall cost of ownership.

U.S. Patent No. 11,702,331 discloses beverage dispensing machines with dispensing valves in which a sensed flow rate is used to meter a flow rate of a syrup and/or diluent of a mixed beverage to maintain a predetermined ratio of syrup and diluent in the mixed beverage.

U.S. Patent No. 5,607,083 discloses a post-mix beverage dispensing valve with a flow controller for ratioing of carbonated water and syrup beverage components. Solenoid operated banjo valves to control the flow of the carbonated water and syrup beverage components therethrough.

U.S. Patent No. 7,290,680 discloses a post-mix beverage valve that provides for automatic, accurate beverage ratioing. A valve body can be assembled, and includes a water flow hard body, syrup body and common nozzle body. The water and syrup flow bodies define flow channels and include one end for connection to water and syrup respectively, and opposite ends for fluid connection to the nozzle body. The water flow channel includes a turbine flow sensor connected to a micro-controller determining the water flow rate. A stepper motor on the water body controls a rod in the flow channel in conjunction with a V-groove.

U.S. Patent No. 10,408,356 discloses a valve that includes a housing defining a chamber with an inlet for receiving a fluid and an outlet for dispensing the fluid. A piston is located in the chamber and subjected to a fluid pressure exerted by the fluid received via the inlet. A plunger is received in the chamber, and the fluid pressure tends to move the piston towards the plunger. A spring tends to move the piston away from the plunger, against the fluid pressure. The plunger is axially registered in the chamber in discrete plunger positions, and each plunger position sets a discrete limit on axial movement of the piston thereby determining a predetermined flow characteristic of the fluid dispensed via the outlet.

U.S. Patent No. 10,364,136 discloses a valve device configured to interact with an inlet stream, the inlet stream having a first pressure, the valve having an outlet area with an outlet stream, the outlet stream having a separate pressure and a solenoid configured to interact with the outlet stream.

Each of the above patents are incorporated by reference in their entireties.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a constant flow device is provided. The constant flow device includes a valve body having an inlet portion with a fluid inlet and an outlet portion with a fluid outlet, the inlet portion and outlet portion forming a cavity. The constant flow device includes a sleeve insertable within the cavity, the sleeve defining a guide channel and having a plurality of holes. The constant flow device includes an adjustment plug configured for at least partial insertion in the cavity and axial engagement with the sleeve, the adjustment plug having a body portion. The constant flow device includes an end plate configured to retain the body portion within the cavity. The constant flow device includes a piston within the guide channel of the sleeve and axial to the adjustment plug, the piston forming a fluid passage extending axially therethrough, the fluid passage being in fluid communication with the fluid inlet and the fluid outlet, wherein the piston is configured for axial movement within the sleeve to regulate fluid flow at the fluid outlet. The constant flow device includes a biasing member positioned between the adjustment plug and the piston, wherein the biasing member is configured to provide an elastic force on the piston in a direction toward the fluid inlet.

According to other aspects of the present disclosure, the constant flow device may include one or more of the following features. The sleeve may be integral with the body portion of the adjustment plug. The biasing member may be a spring. An outer peripheral wall of the piston may be in contact with the inner peripheral wall of the sleeve. The plurality of holes may be circumferentially spaced about the sleeve at a position along a movement path of the piston. The adjustment plug may be one adjustment plug of a plurality of interchangeable adjustment plugs, each adjustment plug configured to provide a different flow rate for a given fluid. The body portion may have an internal end wall configured for engagement with the biasing member, wherein the internal end wall of each adjustment plug of the plurality of adjustment plugs defines a compression distance of the biasing member, the compression distance controlling the different flow rate of the adjustment plug of the plurality of adjustment plugs.

According to other aspects of the present disclosure, the constant flow device may further include an adjustment rod configured to be translatably received within a through hole of the body portion, wherein a boss of the adjustment rod is configured for engagement with the biasing member. The constant flow device may further include a sealing ring inset within the boss, the sealing ring forming a seal between the adjustment rod and the body portion. Translation of the adjustment rod may move the boss to adjust compression on the biasing member. The constant flow device may further include a screw sleeve, and the adjustment rod may be threadedly connected to the screw sleeve to translate the adjustment rod within the through hole of the body portion. The screw sleeve may be integral with the body portion. An end wall of the screw sleeve may be configured for engagement with the boss of the adjustment rod at a side opposite engagement with the biasing member, wherein engagement of the end wall by the boss defines a minimum compression on the biasing member by the adjustment rod. The constant flow device may further include a cap extending over the screw sleeve and the adjustment rod, the cap secured to the body portion by the end plate, the cap including an internal ledge configured for engagement with the screw sleeve and an end wall of the screw sleeve configured for engagement with the boss of the adjustment rod at a side opposite engagement with the biasing member, wherein engagement of the end wall by the boss defines a minimum compression on the biasing member by the adjustment rod. The cap may be one cap of a plurality of caps, each cap of the plurality of caps defining a different axial position of the internal ledge, whereby each cap of the plurality of caps defines a different minimum compression of the biasing member. The constant flow device may further include an adjustment cover secured over the cap, the adjustment cover having a plurality of cover steps internal to the adjustment cover and the cap having at least one outwardly extending projection configured for selective engagement with the cover steps to define a position of the cap and the internal ledge of the cap in the axial dimension.

According to other aspects of the present disclosure, the constant flow device may further include a cover configured to secure over an exposed portion of the adjustment plug. The constant flow device may further include an adjustment plug housing configured to receive the sleeve and body portion therein, wherein the adjustment plug housing is configured to be inserted within the cavity and secured within the cavity by a rotational engagement between a projection of the adjustment plug housing within a slot of the valve body. The constant flow device may further include at least two outlet pipes spaced apart from each other, one of the outlet pipes configured for fluid engagement with the fluid outlet of the valve body, a deformable portion disposed between the adjacent outlet pipes, a sealing plate movably inserted within the deformable portion, and a solenoid connected to the sealing plate to move the sealing plate between open and closed positions to respectively permit or occlude fluid flow from the fluid outlet. According to another aspect of the present disclosure, a beverage valve is provided. The beverage valve includes a syrup system and a diluent system, and further includes at least one constant flow device as described above within at least one of the syrup system and/or the diluent system to respectively regulate a flow of syrup and/or diluent in the valve.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 depicts an example of a beverage dispenser.

FIG. 2 depicts an example of a beverage valve.

FIG. 3 is an exploded view of the internal components of an example of a beverage valve.

FIG. 4 is a cross-sectional view of an example of a constant flow rate valve.

FIG. 5 is a cross-sectional view of a additional example of a constant flow rate valve.

FIG. 6 is an isometric view of an example of the housing of a constant flow rate valve.

FIG. 7 is a cross-sectional view of an example of the flow control components of a beverage dispensing valve.

FIG. 8 is a side view of an example of a constant flow rate valve.

FIG. 9 is a side view of an alternative arrangement of a constant flow rate valve.

FIG. 10 is an isometric view of an alternative example of a beverage valve with constant flow control.

FIG. 11 illustrates two cross-sectional views of constant flow rate valve assemblies shown side by side.

FIG. 12 is an isometric view of a further example of an adjustment plug.

FIG. 13 is a detailed view of a portion of the adjustment plug of FIG. 12.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

In the following description, a great deal of specific detail is given to provide a more thorough understanding of the disclosure. However, a person of ordinary skill in the art will further recognize from the present disclosure that examples disclosed herein may be implemented with more or fewer details than as described. In order to avoid confusion with the embodiment of the present invention, some technical features commonly known in the art are not described.

In this document, ordinal words such as "first" and "second" referenced in the present invention are merely identifications and do not have any other meaning, such as a specific order. And, for example, the term "first part" itself does not imply the existence of a "second part,” the term "second part" does not in itself imply the existence of the "first part.”

In this article, "up,” "down,” "front,” "back,” "left,” "right,” etc., are only used to indicate the relative positional relationship between the related parts, and not to define the absolute position of these related parts.

It should be noted that this article is used to describe the directional terms of the beverage machine, such as "vertical,” "directional.”

Up, down, above, below, etc., are relative to the beverage dispenser in an upright position. Understandably, the beverage dispenser is placed and used in an upright position.

For the purposes of this document, "equal,” "same,” etc., are not strictly mathematical and/or geometric limitations, but also include errors that are understandable to those skilled in the art and are permissible for manufacture or use, etc.

Unless otherwise noted, the numerical range in this article includes not only the entire range within its two endpoints.

The illustrative embodiments according are now described in more detail with reference to the accompanying drawings. However, these examples can be implemented in a number of different forms and should not be construed as confined to the embodiments described here. It should be understood that these embodiments are provided in order to make the disclosure of the present invention thorough and complete, and to construct these exemplary embodiments.

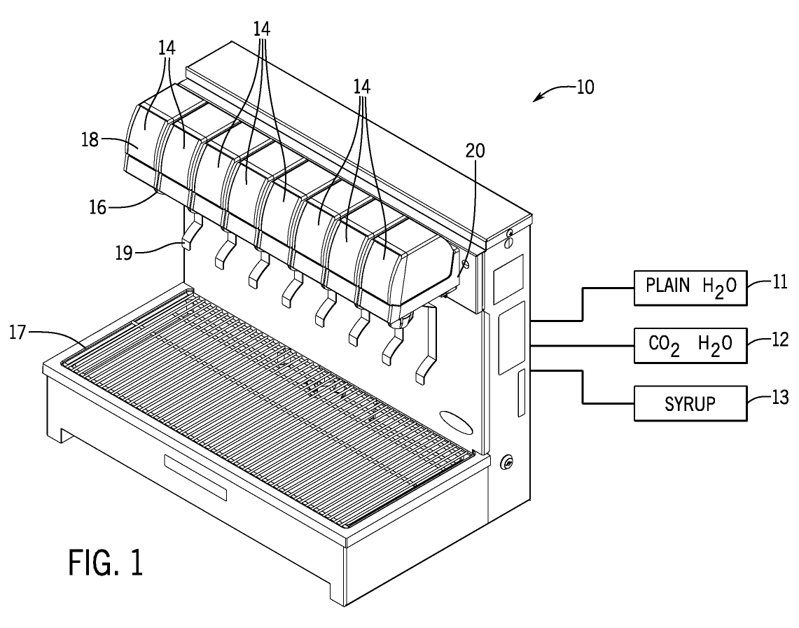

FIG. 1 depicts an example of a beverage dispenser 10. Beverage dispensers 10 are widely used to create and deliver beverages to end users in different settings (e.g. restaurants, convenience stores). The beverage dispenser 10 includes a plurality of beverage valves 14 that operate to each dispense a mixed beverage. The beverage valves 14 are fluidly connected through the beverage dispenser 10 to a plurality of fluid sources, for example, a plain water source 11, e.g. a facility water line, a carbonated water source 12, e.g. a carbonator provided internal or external to the beverage dispenser 10, and one or more concentrated beverage flavor syrup sources 13, e.g. refillable or replaceable containers of concentrate fluid.

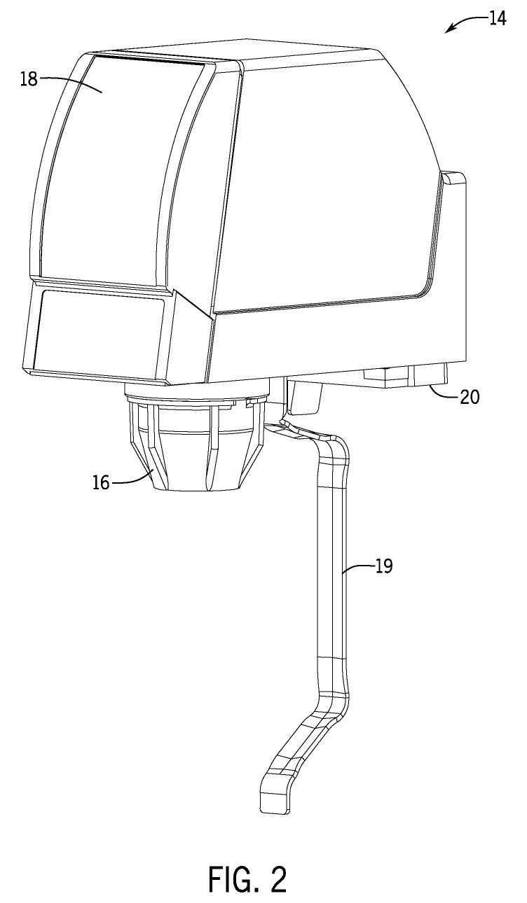

FIG. 2 is perspective view of a beverage valve 14 for a beverage dispenser 10. A backblock 20 is connected to the beverage valve 14 and facilitates the fluid and physical connection of the beverage valve 14 in the beverage dispenser 10. The backblock 20 is fluidly connected to the plain water source 11, the carbonated water source 12, and the syrup source 13. The backblock 20 further provides a releasable physical connection between the beverage valve 14 and the structure of the beverage dispenser 10. The backblock 20 selectively permits fluid flow therethrough from the sources 11, 12, 13 to the beverage valve 14. The beverage valve 14 may be operable upon actuation by the user to dispense one or more combinations of the fluids passed to it through the backblock 20. Non-limiting examples of structures, functions, and operations of the backblock 20 are provided in further detail in US Patent No. 11,724,928, entitled "Beverage Dispensing Machines and Backblocks Thereof," and which is incorporated by reference herein in its entirety.

Operation of the beverage valve 14 may be controlled by an actuator 19 which may be a lever as depicted in FIG. 2, or also within the present disclosure may include push buttons, a proximity sensor, touch screens, wireless inputs, computer/automated inputs, and/or other forms of valve operation, for example but not limited to those as disclsoed in US Patent No. 11,591,205, "Touchless Beverage Dispenser Valve," and which is incorporated by reference herein in its entirety. Upon actuation of the beverage valve 14, the beverage valve 14 exemplarily operates to concurrently dispense a diluent e.g. plain water from the plain water source 11 or carbonated water from the carbonated water source 12, and at least one concentrated beverage flavoring syrup from the syrup source 13 through a nozzle 16 into a receptacle such as a cup to form a post-mix beverage, e.g. a carbonated cola soda. A drip tray 17 below the nozzle 16 catches any overrun of the dispensed beverage. A cover 18 is secured about the components of the beverage valve 14, to protect the operational components of the beverage valve 14 as well as to improve aesthetics of the valve 14 to customers. Additional description of examples of valves is found in “Beverage Dispensing Machines with Fixed Ratio Mechanical Valves,” US Patent Application No. 19/325,348, the contents of which is incorporated by reference herein in its entirety.

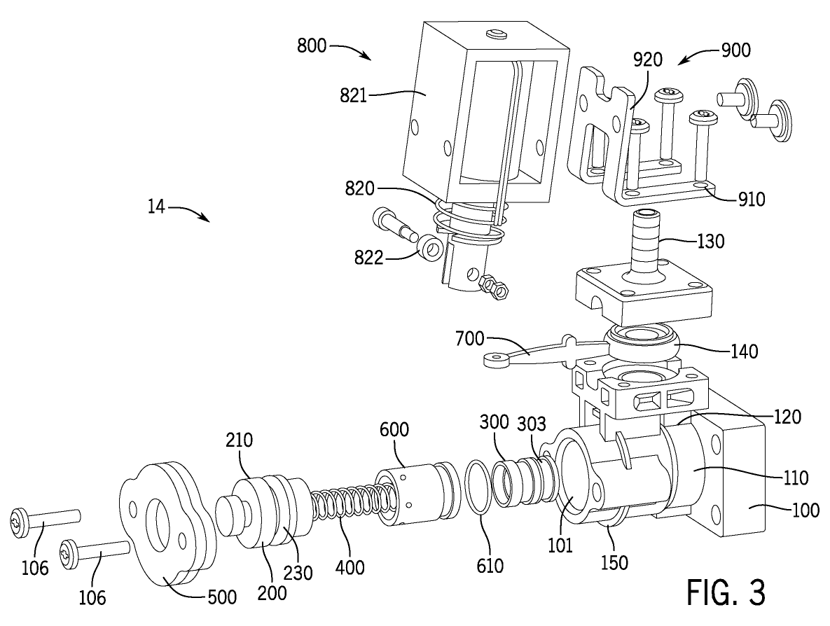

FIG. 3 is an exploded isometric view of the beverage valve 14 assembly. A valve body 100 forms the main structure and defines a cavity 101 that receives internal flow control components. The valve body 100 includes an inlet portion 110 positioned at one end and further includes an outlet portion. The inlet portion 110 includes a cavity end wall 111 and a cavity side wall 112 is jointly defined by the inlet portion and the outlet portion 120. An outlet pipe 130 extends from the outlet portion 120 for fluid discharge. A deformable portion 140 is positioned adjacent to the outlet pipe 130 to accommodate movement of sealing components. A reinforcing rib 150 extends circumferentially around the exterior surface of the valve body 100, providing structural support. The reinforcing ribs 150 on the outer periphery of the valve body 100 may extend in the circumferential direction and may be spaced along the circumferential direction or axial direction to improve strength and prevent deformation due to water hammer.

An adjustment plug 200 is configured for at least partial insertion into the cavity 101 of the valve body 100. The adjustment plug 200 includes a body portion 210. A sealing ring 230 is disposed between the adjustment plug 200 and the valve body 100 to provide a sealed connection. An end plate 500 is detachably mounted to the valve body 100 using bolts 106 to retain the body portion 210 within the cavity 101. The end plate 500 is configured to retain the body portion 210 in position within the cavity 101.

A sleeve 600 is positioned within the cavity 101 between the adjustment plug 200 and the inlet portion 110. The sleeve 600 defines a guide channel and comprises a plurality of holes. The sleeve 600 is insertable within the cavity 101 and is configured for axial engagement with the adjustment plug 200. In some cases, the sleeve 600 may be integral with the body portion 210 of the adjustment plug 200. In other examples, the adjustment plug 200 and the sleeve 600 may be separate components that are retained within a housing, the housing being insertable into the cavity 101. A sealing ring 610 is disposed between the sleeve 600 and the valve body 100 to provide a sealed connection.

A piston 300 is movably disposed within the guide channel of the sleeve 600 and is axial to the adjustment plug 200. The piston 300 forms a fluid passage extending axially therethrough. The fluid passage is in fluid communication with a fluid inlet 111 of the inlet portion 110 and a fluid outlet 103 of the outlet portion 120. The piston 300 is configured for axial movement within the sleeve 600 to regulate fluid flow at the fluid outlet 103. The outer peripheral wall of the piston 300 includes grooves 303 extending circumferentially to reduce friction between the piston 300 and the sleeve 600. A biasing member 400 is positioned between the adjustment plug 200 and the piston 300. The biasing member 400 is configured to provide an elastic force on the piston 300 in a direction toward the fluid inlet.

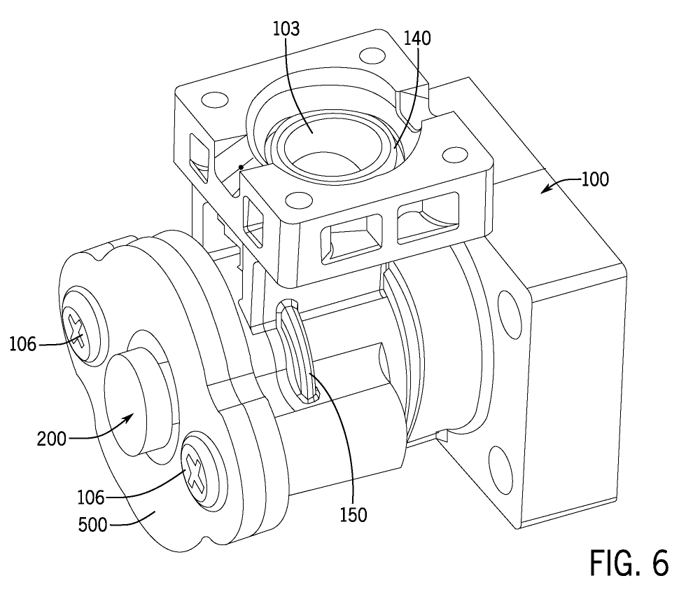

FIG. 6 is an isometric view of the constant flow rate valve assembly showing the valve body 100 and the fluid outlet 103 thereof. The reinforcing rib 150 extends along the exterior surface of the valve body 100, providing structural support to the housing and helping to prevent deformation during operation, particularly under conditions that may cause water hammer effects. The deformable portion 140 is positioned adjacent to the fluid outlet 103 to accommodate movement of sealing components during valve operation. The adjustment plug 200 is positioned at one end of the valve body 100, and the end plate 500 is detachably mounted to the valve body 100 using the bolts 106.

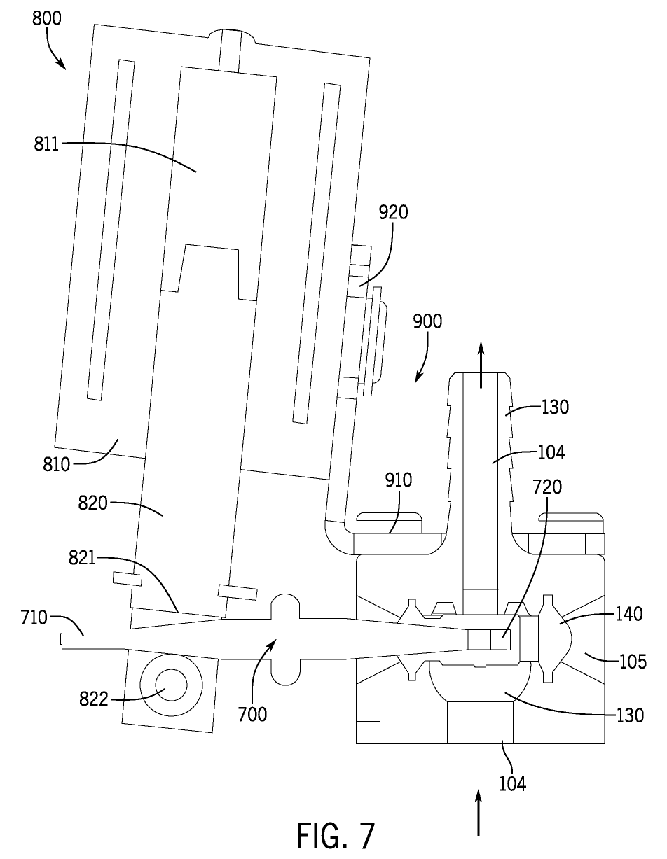

FIG. 7 is a cross-sectional view of a valve opening and closing assembly showing interaction of components for controlling fluid flow through an outlet channel 104. A sealing plate 700 is inserted through a through groove 105 formed in the valve body 100 structure. The sealing plate 700 extends between a first end 710 and a second end 720 along a length direction of the sealing plate 700. The first end 710 is connected to the valve body 100, while the second end 720 is connected to a solenoid 800 that operates to drive movement of the sealing plate 700. The sealing plate 700 is configured as a lever structure that rotates on the valve body 100 through a pivot shaft to achieve opening and closing control with a smaller driving force.

The solenoid 800 includes an active member 810 and a driven member 820. The solenoid 800 may be a stepping motor, a servo motor, a pneumatic cylinder, a hydraulic cylinder, or an electromagnetic driving member. In some cases, the active member 810 is an electromagnetic coil with a slide way 811 provided inside, and the driven member 820 is a plunger slidably connected to the slide way 811. The driven member 820 is provided with a clamping part 821 and a rolling member 822 spaced apart along the length direction of the solenoid 800. The second end 720 of the sealing plate 700 is positioned between the clamping part 821 and the rolling member 822, enabling the solenoid 800 to drive rotational movement of the sealing plate 700. The rolling member 822 may be a roller that cooperates with the sealing plate 700 to reduce relative friction when the sealing plate 700 acts. The sealing plate 700 may be provided with guide inclined surfaces adapted to the clamping part 821 and the rolling member 822 to reduce relative friction during movement.

A bracket 900 is connected between the valve body 100 and the solenoid 800, providing structural support and maintaining proper alignment. The bracket 900 includes a first bracket 910 connected to the valve body 100 and a second bracket 920 connected to the active member 810 of the solenoid 800. The first bracket 910 and the second bracket 920 are arranged at an angle to each other. The angle between the first bracket 910 and the second bracket 920 may be exemplarily 90°, 85°, or 80°. The bracket 900 may be made of high-strength metal such as aluminum alloy or stainless steel, or engineering plastic to improve durability and corrosion resistance.

The sealing plate 700 is configured to move within the deformable portion 140 disposed between adjacent outlet pipes 130. At least two outlet pipes 130 are spaced apart from each other, with one of the outlet pipes 130 configured for fluid engagement with the fluid outlet 103 of the valve body 100. The deformable portion 140 is disposed between the adjacent outlet pipes 130. The deformable portion 140 may be configured as an annular structure to facilitate connection with the outlet pipe 130 and may be made of a deformable material to adapt to the movement of the sealing plate 700. The sealing plate 700 is movably inserted within the deformable portion 140, allowing the sealing plate 700 to selectively block or open fluid flow through the outlet pipe 130 when driven by the solenoid 800. The solenoid 800 is connected to the sealing plate 700 to move the sealing plate 700 between open and closed positions to respectively permit or occlude fluid flow from the fluid outlet 103. The connection region between the deformable portion 140 and the sealing plate 700 forms an elastic support point that serves as the pivot shaft for rotation.

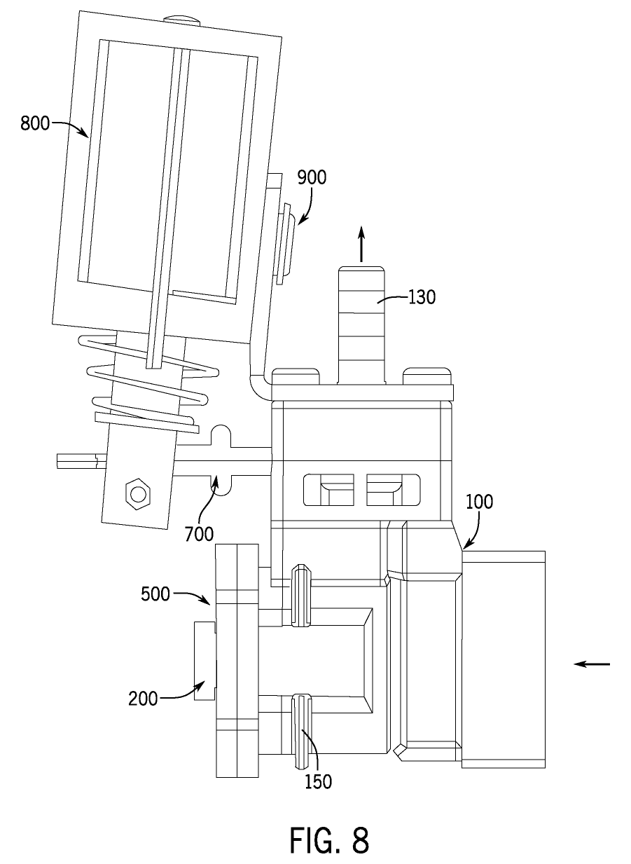

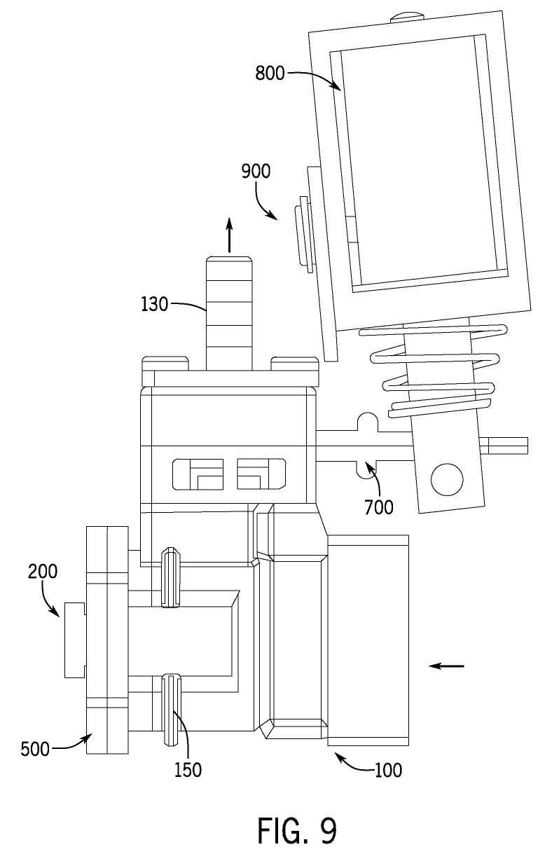

FIGS. 8 and 9 are side views of examples of the disclosed constant flow rate valve assembly. The reinforcing rib 150 extends circumferentially around the exterior surface of the valve body 100. The adjustment plug 200 is positioned at one end of the valve body 100, and the end plate 500 is detachably mounted to secure the adjustment plug 200 in position. The sealing plate 700 extends from the valve body 100 and is configured to selectively block or open fluid flow through the outlet pipe 130. The solenoid 800 is connected to the sealing plate 700 and operates to drive movement of the sealing plate 700 between open and closed positions. The bracket 900 is connected between the valve body 100 and the solenoid 800, providing structural support and maintaining proper alignment of the solenoid 800 relative to the valve body 100.

The valve body 100 may have a plurality of through grooves 105 arranged at intervals around the circumference of the deformable portion 140, allowing the sealing plate 700 to be installed at different angles to adapt to more usage environments. In some cases, the lower part of the valve body 100 may feature two opposing grooves, allowing the sealing plate 700 and lever to be installed either forward or backward to meet different spatial requirements on-site.

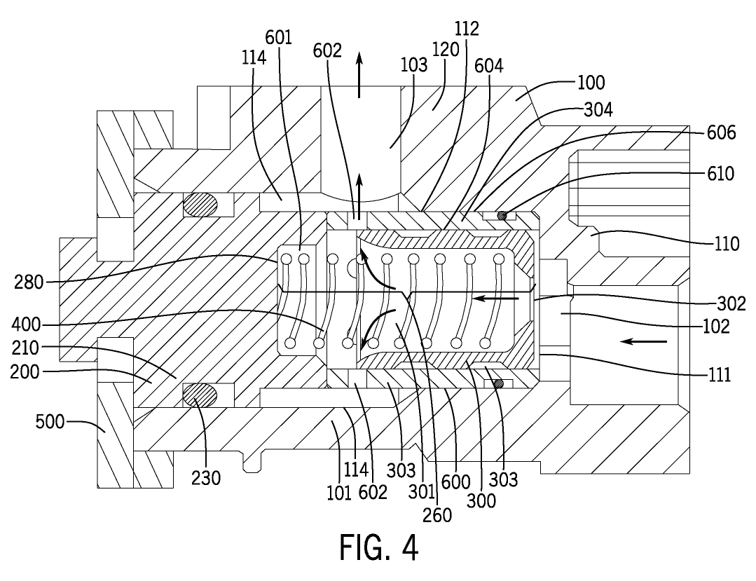

FIG. 4 is a cross-sectional view of the flow regulator of the constant flow rate valve showing the internal arrangement of components. The valve body 100 defines the cavity 101 that houses the internal components of the assembly. The valve body 100 includes the inlet portion 110 having the cavity end wall 111 and the cavity side wall 112 is defined in part by both the inlet portion 110 and the outlet portion 120. A fluid inlet 102 is formed through the cavity end wall 111 for receiving fluid into the cavity 101. The outlet portion 120 includes at least a portion of the cavity side wall 112 and the fluid outlet 103 therethrough for dispensing fluid from the assembly as described herein. The central axis of the fluid inlet 102 may intersect with or be skew to the central axis of the fluid outlet 103, enabling layout optimization according to different installation space constraints.

The adjustment plug 200 is installed within the cavity 101 opposite the cavity end wall 111. The adjustment plug 200 includes the body portion 210 that is sealed against the valve body 100 by the sealing ring 230. An annular cove 114 is defined between the cavity side wall 112 and a portion of the adjustment plug 200. The adjustment plug 200 is secured in position by the end plate 500 that is mounted to the valve body 100 exemplarily with a pair of threaded fasteners (e.g. FIG. 3), placing a retentive force on the adjustment plug 200 in a direction along an axis of the cavity 101. The body portion 210 comprises an internal end wall 280 configured for engagement with the biasing member 400.

The sleeve 600 is positioned within the cavity 101 between the adjustment plug 200 and the cavity end wall 111. While the sleeve 600 is shown as a separate component, it is recognized that in other examples, the sleeve may be integral with the body portion 210. The sleeve 600 has an outer peripheral surface 604 and an inner peripheral surface 606 that defines a guide channel 601. The guide channel 601 is in fluid communication with the fluid inlet 102. A plurality of constant flow holes 602 are formed through the side wall of the sleeve 600, providing fluid communication between the guide channel 601 and the fluid outlet 103 through the annular cove 114, which may further be partially defined between the cavity side wall 112 and the sleeve 600. The plurality of constant flow holes 602 may be arranged in an array along the circumferential direction of the sleeve 600 to enable more even fluid distribution when fluid flows from the constant flow holes 602 to the fluid outlet 103. The sealing ring 610 is disposed between the sleeve 600 and the valve body 100 to provide a sealed connection. The end plate 500 retains the adjustment plug 200 in axial engagement with the sleeve 600 and the sleeve 600 in contact with the cavity end wall 111. Two axial ends of the sleeve 600 may respectively abut against the adjustment plug 200 and the inlet portion 110 for fixed positioning inside the valve body 100.

The piston 300 is movably disposed within the guide channel 601 of the sleeve 600. The piston 300 has an outer peripheral wall 304 that contacts the inner peripheral surface 606 of the sleeve 600. The piston 300 is axially penetrated to form a fluid channel 301, and a piston through hole 302 is formed at the end of the piston 300 proximate to the cavity end wall 111. The diameter of the piston through hole 302 may be 1-5 mm. The diameter of the fluid inlet 102 may be 10-20 mm. The outer peripheral wall 304 of the piston 300 includes the grooves 303 extending circumferentially along the outer peripheral wall 304 and spaced or continuous along an axial direction to reduce friction between the piston 300 and the sleeve 600.

The biasing member 400 is connected between the adjustment plug 200 and the piston 300. The biasing member 400 may be a spring, such as a coil spring or a wave spring. The biasing member 400 provides an elastic force that urges the piston 300 toward the cavity end wall 111 and the fluid inlet 102. At least part of the biasing member 400 may extend into the fluid channel 301 of the piston 300 to reduce additional space requirements and make the device more compact. The preset flow rate of the constant flow device may be adjusted by replacing the biasing member 400 with different stiffness, free length, maximum compression, and restoring force characteristics.

Arrows in FIG. 4 indicate the fluid flow path, showing fluid entering through the fluid inlet 102, passing through the piston through hole 302 and the fluid channel 301, exiting through the constant flow holes 602, and flowing out through the fluid outlet 103. The position of the piston 300 within the guide channel 601 determines the exposed area of the constant flow holes 602, thereby regulating the fluid flow rate through the assembly. The plurality of constant flow holes 602 are circumferentially spaced about the sleeve 600 at a position along a movement path of the piston 300.

The adjustment plug 200 may be one adjustment plug of a plurality of interchangeable adjustment plugs, each adjustment plug configured to provide a different flow rate for a given fluid. A coarse spacing 260 is defined between the internal end wall 280 of the body portion 210 and the biasing member 400. The internal end wall 280 of each adjustment plug of the plurality of adjustment plugs defines a compression distance of the biasing member 400. The compression distance controls the different flow rate of the adjustment plug of the plurality of adjustment plugs. By selecting an adjustment plug 200 from the plurality of interchangeable adjustment plugs having different dimensions, different preset flow rates may be achieved without on-site adjustment.

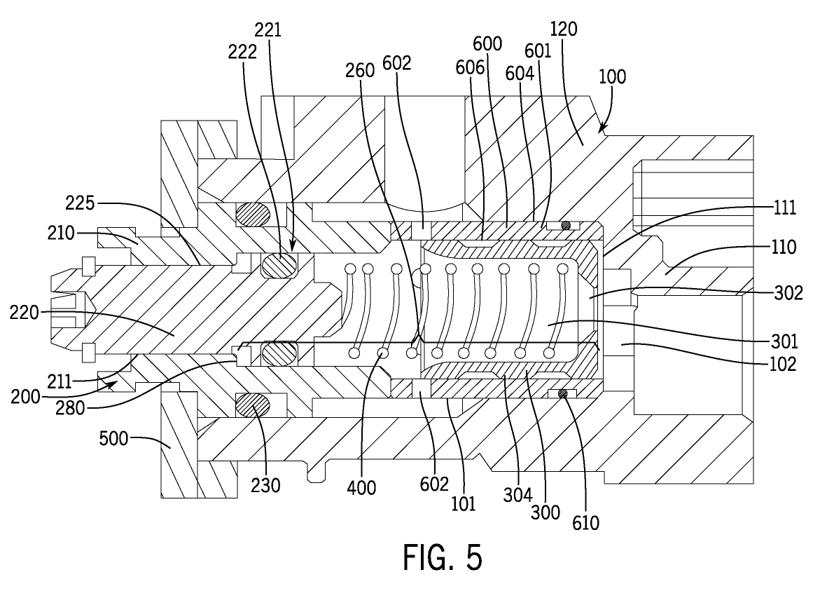

FIG. 5 illustrates a cross-sectional view of an alternative example of the flow controller of a constant flow rate valve assembly featuring an adjustment rod 220 in the adjustment plug 200 for fine flow rate adjustment. The valve body 100 defines the cavity 101 that houses the flow control components. The fluid inlet 102 is formed at one end of the valve body 100, and the inlet portion 110 extends from the valve body 100. The inlet portion 110 includes the cavity end wall 111, and the outlet portion 120 is positioned opposite the inlet portion 110.

The adjustment plug 200 is installed at one end of the cavity 101. The adjustment plug 200 includes the body portion 210 having a through hole 211 extending therethrough. The adjustment rod 220 is configured to be translatably received within the through hole 211 of the body portion 210. The adjustment rod 220 extends into the cavity 101. A boss 221 is provided at the end of the adjustment rod 220 that faces into the cavity 101. The boss 221 of the adjustment rod 220 is configured for engagement with the biasing member 400. A sealing ring 222 is inset within the boss 221, the sealing ring 222 forming a seal between the adjustment rod 220 and the body portion 210. The sealing ring 230 is disposed between the adjustment plug 200 and the valve body 100 to provide a sealed connection therebetween.

A threaded interface 225 enables adjustment of the axial position of the adjustment rod 220 within the body portion 210. An end wall 280 of the body portion 210 may be configured for engagement with the boss 221 of the adjustment rod 220 at a side opposite engagement with the biasing member 400. Engagement of the end wall 280 by the boss 221 defines a coarse spacing 260 for a minimum compression on the biasing member 400 by the adjustment rod 220. Translation of the adjustment rod 220 moves the boss 221 to adjust compression on the biasing member 400, thereby providing fine calibration of the flow rate.

The sleeve 600 is positioned within the cavity 101. The sleeve 600 defines the guide channel 601 extending axially therethrough and has the outer peripheral surface 604 and the inner peripheral surface 606. In examples, the sleeve 600 may be integrally formed with the body portion 210. The plurality of constant flow holes 602 are formed through the side wall of the sleeve 600, providing fluid communication between the guide channel 601 and the fluid outlet 103. The sealing ring 610 is disposed between the sleeve 600 and the valve body 100.

The piston 300 is movably disposed within the guide channel 601 of the sleeve 600. The piston 300 has the outer peripheral wall 304 that contacts the inner peripheral surface 606 of the sleeve 600. The fluid channel 301 extends axially through the piston 300, and the piston through hole 302 is formed at the end of the piston 300 adjacent to the fluid inlet 102. The biasing member 400 is connected between the boss 221 of the adjustment rod 220 and the piston 300. The biasing member 400 provides an elastic force that urges the piston 300 toward the fluid inlet 102. The end plate 500 is secured to the valve body 100 and retains the adjustment plug 200 in position within the cavity 101.

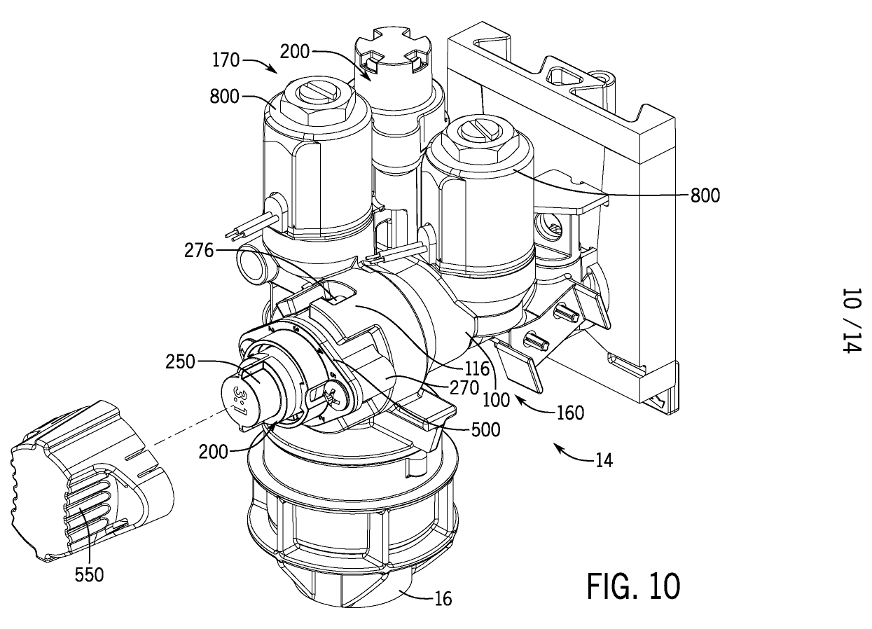

FIG. 10 depicts an arrangement of a beverage valve 14 that is alternative or additional to the example show in FIG. 3. It will be recognized that the flow regulators as disclosed herein may be used with either of the valves 14 as depicted in FIGS. 3 or 14, or other beverage valve arrangements as may be recognized in view of the present disclosure. The beverage valve 14 uses one or more adjustment plugs 200 as the flow regulator for syrup and/or diluent constituents in dispensing a mixed beverage. The valve body 100 forms the main structural housing of the assembly and is configured to receive internal flow control components and provide fluid pathways for beverage dispensing.

The beverage valve includes a syrup system 160 and a diluent system 170. The syrup system 160 and the diluent system 170 each include a solenoid 800 operating a shut-off valve to selectively permit or occlude the flow of syrup or diluent. The adjustment plug 200 serves as the flow regulator to provide a predetermined flow rate of each constituent to achieve a predetermined ratio of syrup to diluent according to a beverage recipe. The beverage valve 14 includes at least one of the disclosed constant flow devices within at least one of the syrup system 160 and/or the diluent system 170 to respectively regulate a flow of syrup and/or diluent in the valve 14.

The valve body 100 includes a slot 116 formed in an exterior surface thereof. The slot 116 is configured to receive a projection 276 which extends radially outward from the adjustment plug 200. A rotation, exemplarily through 10-90 degrees, sets the projection 276 within the slot 116 to releasably secure the adjustment plug 200 into position within the valve body 100. The projection 276 is configured for engagement with the slot 116 of the valve body 100 to secure the adjustment plug 200 within the valve body 100 through rotational engagement.

A cap 250 is positioned at an upper portion of the adjustment plug 200, as will be described in further detail herein. The end plate 500 is positioned adjacent to the adjustment plug 200 and is configured to secure the adjustment plug 200 to a housing 270, as will also be described in further detail herein. The adjustment plug 200, including the housing 270, is axially inserted into the cavity 101 of the valve body 100 and removably secured therein by a rotation to engage the projection 276 within the slot 116.

As described previously, examples of the adjustment plug 200 may provide both a coarse adjustment of flow rate and a fine adjustment, for example, coarse adjustment by selecting one adjustment plug of a plurality having certain dimensions, and then calibrating that adjustment plug by threaded translation of the adjustment rod 220 therein. A cover 550 is shown separated from the assembly and is configured to secure over an exposed portion of the adjustment plug 200. The cover 550 limits further access to the flow control after selection and fine tuning/calibration of the flow regulated by the adjustment plug 200. The cover 550 may also provide protection and improved aesthetics.

The nozzle 16 extends from a lower portion of the valve body 100 and is positioned to dispense mixed beverages into a receptacle. While the description herein has focused on flow regulation of the syrup within the beverage valve 14, the adjustment plug 200 and flow regulation may similarly be used with respect to the diluent in the diluent system 170.

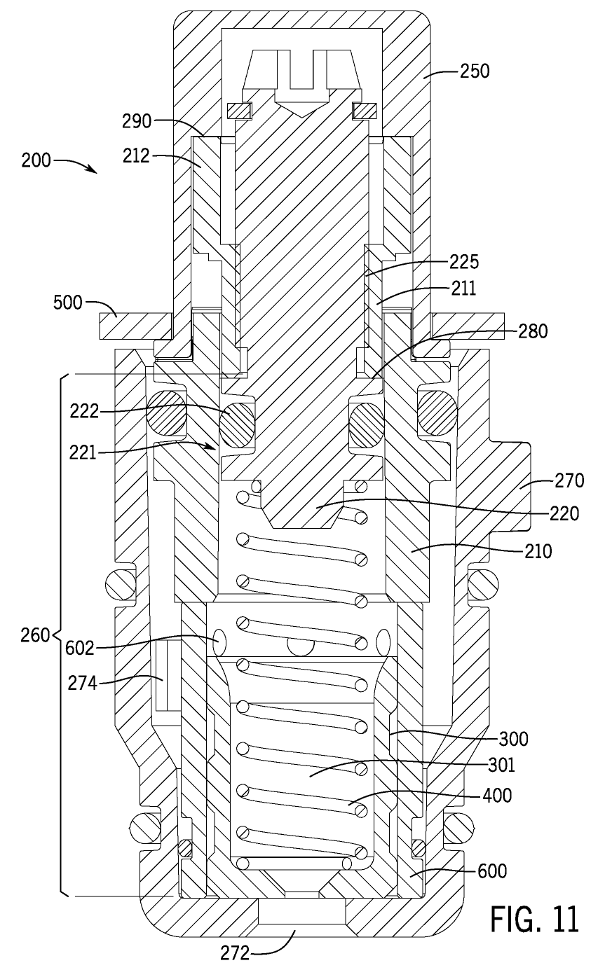

FIG. 11 illustrates two cross-sectional views of constant flow rate valve assemblies shown side by side, depicting the internal arrangement of components within the housing structure. The two examples differ in the caps 250 which provide different arrangement and dimensions resulting in a different coarse spacing 260 when other components are held constant. The coarse spacing 260 defines the minimum compression position of the boss 221 of the adjustment rod 220, resulting in two different constant flow rates through the assemblies. The flow rate is ultimately calibrated or fine tuned by translating the adjustment rod 220, exemplarily by threaded engagement, to set the compression on the biasing member 400. Components other than the cap 250 may be the same between the two examples.

In both views shown in FIG. 11, the adjustment plug 200 includes the body portion 210 and a screw sleeve 212 set within the body portion 210. The screw sleeve 212 has the through hole 211 extending axially therethrough. The adjustment rod 220 is received in the through hole 211 and extends into the assembly. The threaded interface 225 enables threaded axial translation adjustment of the rod position within the body portion 210. The boss 221 is provided at the lower end of the adjustment rod 220, the boss 221 being configured for engagement with the biasing member 400. The sealing ring 222 is positioned within the boss 221 between the adjustment rod 220 and the body portion 210 to provide a sealed connection therebetween. In some cases, the screw sleeve 212 and the body portion 210 may be separate components, while in other examples, the screw sleeve 212 and the body portion 210 may be a unitary construction.

The cap 250 is positioned at the uppermost portion of each adjustment plug 200. The cap 250 extends over the screw sleeve 212 and the adjustment rod 220. The cap 250 is secured to the body portion 210 by the end plate 500. The end wall 280 of the screw sleeve 212 is visible below the cap 250. The end wall 280 of the screw sleeve 212 is configured for engagement with the boss 221 of the adjustment rod 220 at a side opposite engagement with the biasing member 400. Engagement of the boss 221 with the end wall 280 defines an extent of translation of the adjustment rod 220 in that direction. Engagement of the end wall 280 by the boss 221 defines the coarse adjustment 260 and the minimum compression on the biasing member 400 by the adjustment rod 220.

The cap 250 includes an internal ledge 290 within the cap 250. The internal ledge 290 is configured for engagement with the screw sleeve 212. The internal ledge 290 abuts an opposite end of the screw sleeve 212 from the end wall 280. Because the screw sleeve 212 abuts the internal ledge 290, the axial location of the internal ledge determines the axial location of the end wall 280 and thus the coarse spacing 260. When the other components such as the body portion 210, the screw sleeve 212, the adjustment rod 220, and the biasing member 400 are constant, the coarse spacing 260 defines a minimum compression placed on the biasing member 400.

The cap 250 may be one cap of a plurality of caps. Each cap of the plurality of caps defines a different axial position of the internal ledge 290. Each cap of the plurality of caps defines a different minimum compression of the biasing member 400. By selecting a cap 250 from the plurality of caps having different dimensions, different preset flow rates may be achieved through the different coarse spacing 260 values.

The sleeve 600 is positioned within the assembly and defines the guide channel extending axially therethrough. The plurality of constant flow holes 602 are formed through the side wall of the sleeve 600, providing fluid communication between the guide channel and a housing outlet 274. In some cases, the sleeve 600 may be integral with the body portion 210.

The piston 300 is movably disposed within the sleeve 600. The piston 300 includes the fluid channel 301 extending axially therethrough for fluid passage. The piston through hole 302 is formed at the end of the piston 300 proximate to the fluid inlet. The biasing member 400, configured as a spring, is connected between the boss 221 of the adjustment rod 220 and the piston 300, providing an elastic force that urges the piston 300 towards the fluid inlet. The position of the piston 300 within the sleeve 600 determines the exposed area of the constant flow holes 602, thereby regulating the fluid flow rate through the assembly.

As further shown in FIG. 11, a housing 270 surrounds the flow control components as described above, internal of the end plate 500. Fasteners through the end plate 500 secure the cap 250 and the adjustment plug 200 to the housing 270. The housing 270 includes a housing inlet 272 at the lower portion through which fluid enters the assembly. The housing outlet 274 is formed through the side wall of the housing 270 for fluid egress. The piston 300 is axially urged against the housing inlet 272 by the biasing member 400. The housing 270 thus packages an assembly that can be inserted into the cavity 101 as one piece.

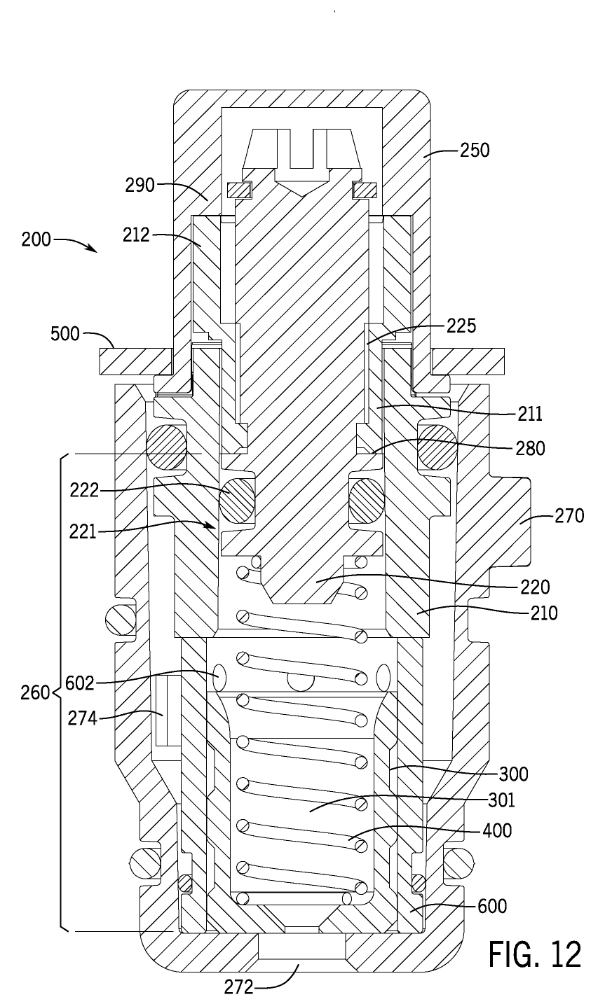

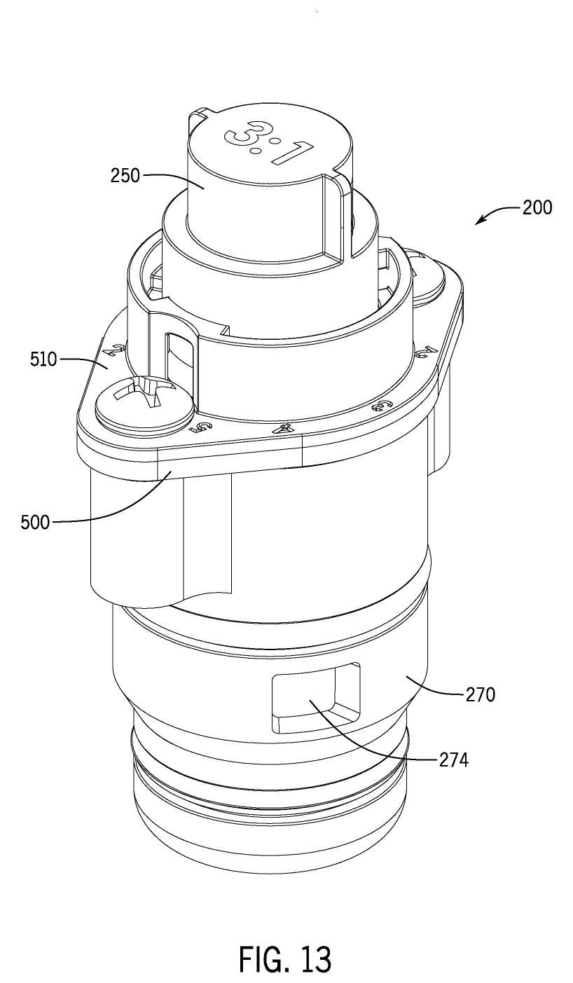

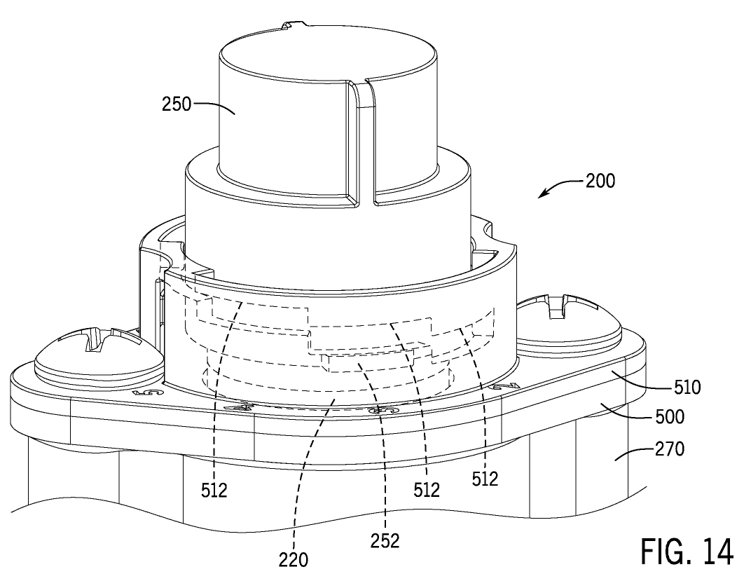

FIG. 12 is an isometric view of a further example of an adjustment plug 200 assembly for a constant flow rate valve. FIG. 13 is a detailed view of a portion thereof. The housing 270 extends from a lower portion of the assembly. The housing 270 forms the main structural body that receives internal flow control components and includes the housing outlet 274 formed through the side wall of the housing 270 for fluid egress. While FIG. 11 depicted examples of interchangable caps for coarse flow control adjustment, FIGS. 12 and 13 depict an example where a single assembly provides different coarse flow control.

The cap 250 is positioned at an external end of the adjustment plug 200. An adjustment cover 510 is positioned over the cap 250. The adjustment cover 510 is secured over the cap 250 by the end plate 500. Fasteners secure the end plate 500 over a respective lip of the adjustment cover 510 to secure the adjustment cover 510 to the housing 270. The adjustment cover 510 includes a plurality of cover steps 512 internal to the adjustment cover 510. The cover steps 512 are arranged around the periphery of the adjustment cover 510, providing a stepped interface for securing the cover. FIG. 13 shows the adjustment cover 510 in a semi-transparent rendering to reveal the cover steps 512. At least one cap projection 252 extends radially outward from the cap 250. The at least one cap projection is configured for selective engagement with the adjustment cover 510. A retention feature (not depicted) may help to retain the at least one cap projection into engagement with a cover step 512 unless under intentional force to engage a different cover step 512.

The cap 250 and the rest of the adjustment plug 200 interact within the adjustment cover 510 by a rotational arrangement. Rotation of the cap 250 causes engagement between the cap projection 252 and one of the plurality of cover steps 512 of the adjustment cover 510. Because the cover steps 512 are at different distances in the axial dimension, selective engagement between the cap projection 252 and the cover steps 512 defines a position of the cap 250 and the internal ledge 290 of the cap 250 in the axial dimension. This selective engagement controls the coarse compression on the biasing member 400 within the housing 270 of the flow regulator. By rotating the cap 250 to engage the cap projection 252 with different cover steps 512, different coarse spacing 260 values may be achieved, resulting in different preset flow rates through the assembly.

The adjustment rod 220 extends centrally through the assembly, connecting to internal flow control components, in exemplarily the same manner as shown and described with respect to FIG. 11. As described previously, the adjustment rod 220 may be translated by threaded engagement to provide fine calibration of the flow rate after the coarse compression is set by the rotational engagement of the cap 250 with the adjustment cover 510.

A number of implementations have been described. Nevertheless, it will be understood that various modifications may be made without departing from the spirit and scope of the disclosure. Accordingly, other implementations are within the scope of the following claims.

1. A constant flow device, comprising:
a valve body comprising an inlet portion having a fluid inlet and an outlet portion having a fluid outlet, the inlet portion and outlet portion forming a cavity;
a sleeve insertable within the cavity, the sleeve defining a guide channel and comprising a plurality of holes;
an adjustment plug configured for at least partial insertion in the cavity and axial engagement with the sleeve, the adjustment plug comprising a body portion;
an end plate configured to retain the body portion within the cavity;
a piston within the guide channel of the sleeve and axial to the adjustment plug, the piston forming a fluid passage extending axially therethrough, the fluid passage being in fluid communication with the fluid inlet and the fluid outlet, wherein the piston is configured for axial movement within the sleeve to regulate fluid flow at the fluid outlet;
a biasing member positioned between the adjustment plug and the piston, wherein the biasing member is configured to provide an elastic force on the piston in a direction toward the fluid inlet.

2. The constant flow device of claim 1, wherein the sleeve is integral with the body portion of the adjustment plug.

3. The constant flow device of claim 1, wherein the biasing member is a spring.

4. The constant flow device of claim 1, wherein an outer peripheral wall of the piston is in contact with the inner peripheral wall of the sleeve.

5. The constant flow device of claim 3, wherein the plurality of holes are circumferentially spaced about the sleeve at a position along a movement path of the piston.

6. The constant flow device of claim 1, wherein the adjustment plug is one adjustment plug of a plurality of interchangeable adjustment plugs, each adjustment plug configured to provide a different flow rate for a given fluid.

7. The constant flow device of claim 6, wherein the body portion comprises an internal end wall configured for engagement with the biasing member, wherein the internal end wall of each adjustment plug of the plurality of adjustment plugs defines a compression distance of the biasing member, the compression distance controlling the different flow rate of the adjustment plug of the plurality of adjustment plugs.

8. The constant flow device of claim 1, further comprising an adjustment rod configured to be translatably received within a through hole of the body portion, wherein a boss of the adjustment rod is configured for engagement with the biasing member.

9. The constant flow device of claim 8, further comprising a sealing ring inset within the boss, the sealing ring forming a seal between the adjustment rod and the body portion.

10. The constant flow device of claim 8, wherein translation of the adjustment rod moves the boss to adjust compression on the biasing member.

11. The constant flow device of claim 8, further comprising a screw sleeve, and the adjustment rod is threadedly connected to the screw sleeve to translate the adjustment rod within the through hole of the body portion.

12. The constant flow device of claim 10, wherein the screw sleeve is integral with the body portion.

13. The constant flow device of claim 12, wherein an end wall of the screw sleeve is configured for engagement with the boss of the adjustment rod at a side opposite engagement with the biasing member, wherein engagement of the end wall by the boss defines a minimum compression on the biasing member by the adjustment rod.

14. The constant flow device of claim 11, further comprising a cap extending over the screw sleeve and the adjustment rod, the cap secured to the body portion by the end plate, the cap including an internal ledge configured for engagement with the screw sleeve and an end wall of the screw sleeve is configured for engagement with the boss of the adjustment rod at a side opposite engagement with the biasing member, wherein engagement of the end wall by the boss defines a minimum compression on the biasing member by the adjustment rod.

15. The constant flow device of claim 14, wherein the cap is one cap of a plurality of caps, each cap of the plurality of caps defining a different axial position of the internal ledge, whereby each cap of the plurality of caps defines a different minimum compression of the biasing member.

16. The constant flow device of claim 14, further comprising an adjustment cover secured over the cap, the adjustment cover comprising a plurality of cover steps internal to the adjustment cover and the cap comprises at least one outwardly extending projection configured for selective engagement with the cover steps to define a position of the cap and the internal ledge of the cap in the axial dimension.

17. The constant flow device of claim 1, further comprising a cover configured to secure over an exposed portion of the adjustment plug.

18. The constant flow device of claim 1, further comprising an adjustment plug housing configured to receive the sleeve and body portion therein, wherein the adjustment plug housing is configured to be inserted within the cavity and secured within the cavity by a rotational engagement between a projection of the adjustment plug housing within a slot of the valve body.

19. The constant flow device of claim 1, further comprising:
at least two outlet pipes spaced apart from each other, one of the outlet pipes configured for fluid engagement with the fluid outlet of the valve body;
a deformable portion disposed between the adjacent outlet pipes;
a sealing plate movably inserted within the deformable portion; and
a solenoid connected to the sealing plate to move the sealing plate between open and closed positions to respectively permit or occlude fluid flow from the fluid outlet.

20. A beverage valve comprising a syrup system and a diluent system, and further comprising at least one constant flow device of claim 1 within at least one of the syrup system and/or the diluent system to respectively regulate a flow of syrup and/or diluent in the valve.
